(19) United States
(12) Patent Application Publication
(10) Pub. No.: US 2009/0143507 A1
(43) Pub. Date: Jun. 4, 2009

(54) Vibration-proof rubber composition of engine mount

(75) Inventor: Yoo Suk Kim, Gyeonggi-do (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/214,620

(22) Filed: Jun. 20, 2008

(30) Foreign Application Priority Data
Nov. 29, 2007 (KR) 10-2007-0123072

(51) Int. Cl. C08L 7/00; C08K 5/3447; C08K 5/17

(52) U.S. Cl. 524/93; 524/575.5; 524/186

(57) ABSTRACT

The present invention relates to a vibration-proof rubber composition provided by replacing conventional vulcanization system with a new hybrid crosslinking system and using 2-mercaptobenzimidazole as a component of an aging inhibitor. With optimized proportions of constituents, the present composition provides improved heat resistance, fatigue resistance, and dynamic characteristics.

### CROSS-REFERENCE TO RELATED APPLICATION

This application claims under 35 U.S.C. §119(a) the benefit of Korean Patent Application No. 10-2007-0123072 filed Nov. 29, 2007, the entire contents of which are incorporated herein by reference.

### BACKGROUND

(a) Technical Field

The present invention relates to a vibration-proof rubber composition, and more particularly to a vibration-proof rubber composition for engine mount of vehicles, which provide superior heat resistance, fatigue resistance, dynamic characteristics and durability.

(b) Background Art

A vibration-proof rubber absorbs vibration and noise during the operation of machinery. In general, a rubber, a polymer material having a chain structure, is sticky and its elasticity varies a lot, and it thus is hard to be used as it is. To solve this problem and provide vibration-proof characteristics, a natural rubber or synthetic rubber is vulcanized.

A vibration-proof rubber used for vehicle engines requires good heat resistance, durability, dynamic characteristics, and so forth. Usually, a vibration-proof rubber has been manufactured by adding a vulcanization accelerator, an aging inhibitor, a filler, etc. depending on applications. In recent years, vehicle engines are required to be operated at a higher temperature than before. They become more and more compact with the recent rapid technical development.

Vibration-proof rubbers that have been used for vehicle engines have drawbacks. For example, their heat resistance is inferior and their dynamic characteristics and other physical properties tend to be deteriorated quickly.

The conventional vibration-proof rubbers for vehicle engines (e.g., engine mount) are prepared typically by adding a filler, sulfur and a vulcanization accelerator to a natural rubber or synthetic rubber to obtain a vibration-proof rubber composition comprising a vulcanization system, and then further adding an activator, an aging inhibitor, an anti-ozone agent, and the like to improve physical properties of the vibration-proof rubber composition.

In general, the vulcanization system is classified into the CV (conventional vulcanization) system and the EV (efficient vulcanization) system as shown below.

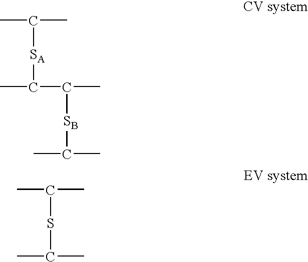

The poly-sulfur bridging in the CV system is superior in room temperature durability and dynamic characteristics because of the flexibility of the sulfur bonding. However, at high temperature, the sulfur bonding is broken and the resultant free sulfur forms mono-sulfur bridges, thereby deteriorating initial physical properties of the vibration-proof rubber. The mono-sulfur bridging in the EV system is superior to the CV system in heat resistance and aging characteristics. But, dynamic characteristics are poor due to insufficient flexibility of the sulfur bonding.

In order to solve these problems, Korean Patent Publication No. 2005-0118802 used a filler comprising a mixture of carbon black FEF and carbon black MT. Korean Patent Publication No. 2003-0017679 used a mixture of two vulcanization accelerators. Korean Patent Publication No. 2004-0000852 used a synthetic rubber with specific composition and proportion. And, Korean Patent Publication No. 2004-0033423 added an anti-ozone agent. But, n one of these satisfy the physical properties required for vibration-proof rubber for vehicle engines.

And, Korean Patent No. 0537101 improved cold resistance of vibration-proof rubber by adding dioctyl phthalate, but heat resistance is insufficient.

Accordingly, there is a need for a vibration-proof rubber composition that can provide excellent heat resistance, dynamic characteristics and durability.

The above information disclosed in the Background section is only for enhancement of understanding of the background of the invention and therefore it may contain information that does not form the prior art that is already known in this country to a person of ordinary skill in the art.

### SUMMARY OF THE DISCLOSURE

To solve the aforesaid problems of the conventional vibration-proof rubbers, the inventors of the present invention have discovered a new hybrid crosslinking system different from the vulcanization system of the conventional vibration-proof rubber compositions, and a method of introducing a heat-resistant aging inhibitor to a vibration-proof rubber composition. With regard to the new hybrid crosslinking system and the introduction of a heat-resistant aging inhibitor, they also have discovered optimum constituents and proportions thereof to provide superior physical properties, particularly dynamic characteristics, heat resistance and durability, compared with the conventional rubber compositions.

In one aspect, the present invention provides a rubber composition comprising a natural rubber, a crosslinking agent, a vulcanization accelerator, an activator, an aging inhibitor and a filler, and at least one of the hybrid crosslinking system 1 and the hybrid crosslinking system 2 shown below:

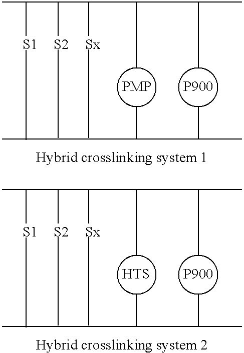

wherein PMP refers to N,N-m-phenylenedimaleimide, P900 refers to 1,3-bis-(citraconimidomethyl)benzene, and HTS refers to hexamethylene-1,6-bis(thiosulfate).

In a preferred embodiment, the vibration-proof rubber composition comprises: 1.5 to 3 parts by weight of the vulcanization accelerator; 0.2 to 0.7 parts by weight of sulfur and 1 to 2.8 parts by weight of a heat-resistant crosslinking agent as the crosslinking agent; 8 to 12 parts by weight of the activator; 5 to 10 parts by weight of the aging inhibitor; and 10 to 50 parts by weight of the filler, per 100 parts by weight of the natural rubber, wherein weight ratio of the vulcanization accelerator to the crosslinking agent is from 1:0.7 to 1:1.

The vibration-proof rubber compositions according to the present invention have excellent heat resistance, dynamic characteristics, durability, etc., compared with conventional vibration-proof rubber compositions. When used in an engine mount for vehicles, the vibration-proof rubber compositions can thus provide various economical advantages.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other features of the invention are discussed infra.

### DETAILED DESCRIPTION

Reference will now be made in detail to the preferred embodiments of the present invention.

As discussed above, in one aspect, the present invention provides a rubber composition comprising a natural rubber, a crosslinking agent, a vulcanization accelerator, an activator, an aging inhibitor and a filler, and at least one of the following hybrid crosslinking systems 1 and 2:

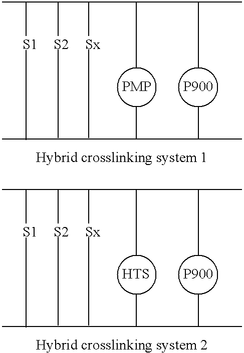

Preferably, the vibration-proof rubber composition may comprise: per 100 parts by weight of natural rubber, 1.5 to 3 parts by weight of a vulcanization accelerator; 0.2 to 0.7 parts by weight of sulfur and 1 to 2.8 parts by weight of heat-resistant crosslinking agent as a crosslinking agent; 8 to 12 parts by weight of an activator; 5 to 10 parts by weight of aging inhibitor; and 10 to 50 parts by weight of a filler, wherein the weight proportion of the vulcanization accelerator to the crosslinking agent is from 1:0.7 to 1:1.

When the vulcanization accelerator is used less than 1.5 parts by weight, the time required for vulcanization increases, thereby resulting in decrease of productivity. On the other hand, when it is used in an amount exceeding 3 parts by weight, scorching may occur, thereby resulting in poor processability.

The crosslinking agent, preferably, comprises sulfur and a heat-resistant crosslinking agent. When the sulfur is used less than 0.2 part by weight, durability and adhesivity of the rubber may become poor. On the other hand, when it is used in an amount exceeding 0.7 part by weight, heat resistance may be insufficient to satisfy the operation temperature limit.

When the heat-resistant crosslinking agent is used less than 1.5 parts by weight, room temperature properties may be deteriorated due to decreased crosslinking density. By contrast, when it is used in an amount exceeding 4.5 parts by weight, aging characteristics may be deteriorated. As the heat-resistant crosslinking agent, PMP may be used along with P900, HTS or both. Whereas PMP provides good heat resistance, fatigue resistance may decrease when it is used in excess, because of insufficient structural flexibility. Use of HTS or P900 may improve dynamic characteristics, but reduce heat resistance. Hence, it is preferable to use PMP along with P900, HTS or both. An optimized content of each constituent is 0.5 to 1.5 parts by weight.

Suitably, the proportion of the vulcanization accelerator to the crosslinking agent may be from 1:0.7 to 1:1, more preferably from 1:0.8 to 1:0.9, based on weight. When the weight proportion of the crosslinking agent is smaller than 0.7, dynamic characteristics may be deteriorated. On the other hand, when the weight proportion of the crosslinking agent exceeds 1, aging characteristics may be deteriorated.

The activator is used to accelerate the crosslinking reaction. When the activator is used less than 8 parts by weight, the crosslinking reaction occurs slowly. In contrast, when it is used in an amount exceeding 12 parts by weight, productivity may decrease because the crosslinking reaction occurs too quickly.

The aging inhibitor is used to inhibit the aging of the vibration-proof rubber composition. When the aging inhibitor is used less than 5 parts by weight, the effect of aging inhibition decreases. In contrast, when it is used in an amount exceeding 10 parts by weight, anti-vibration characteristics may be deteriorated because of unwanted side effect.

The filler is used to improve mechanical properties. When the filler is used less than 10 parts by weight, room temperature properties and damping properties may be deteriorated. By contrast, when it is used in an amount exceeding 50 parts by weight, fatigue resistance may be deteriorated because of reduced dispersibility.

Preferably, the natural rubber may have a Mooney viscosity in the range of from 40 to 80, more preferably from 50 to 70. An example of the repeating unit of the rubber includes, but not limited to, isoprene of the following chemical formula: CH₂═C(CH₃)—CH═CH₂

The heat-resistant crosslinking agent may comprise PMP along with at least one of P900 and HTS. The chemical structures of PMP, P900 and HTS are shown below.

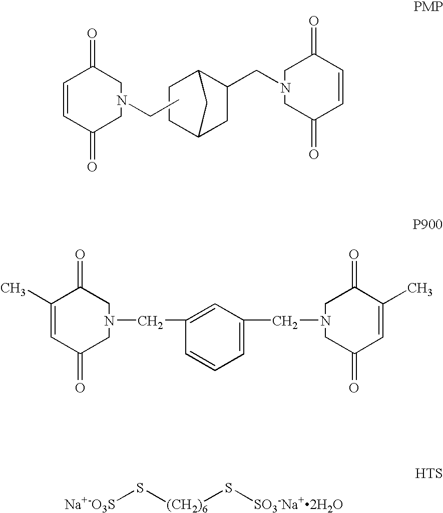

They differ in heat resistance and flexibility of chains depending on their structure. In particularly, PMP improves heat resistance, whereas the use of P900 and HTS prevents deterioration of flexibility and dynamic characteristics.

The vulcanization accelerator may comprise N-cyclehexylbenzothiozole-2-sulfenamide (hereinafter referred to as “CZ”), tetramethylthiuram disulfide (hereinafter referred to as “TT”) or a mixture thereof, and is used to improve quality by reducing vulcanization time, lowering vulcanization temperature and reducing the use of a vulcanization agent.

The activator may comprise stearic acid, zinc oxide or a mixture thereof, and is used to activate the vulcanization accelerator.

The aging inhibitor may comprise N-phenyl-N-isopropyl-p-phenylenediamine (hereinafter referred to as “3C”), 2-mercaptobenzimidazole (hereinafter referred to as “MB”) or a mixture thereof. Preferably, it may further comprise a blooming aging inhibitor. Examples of the blooming aging inhibitor include Sunnoc, Suntite or a mixture thereof.

Suitably, as the aging inhibitor, MB may be used along with 3C, Sunnoc and/or Suntite. MB has been recognized in the art to have insufficient aging inhibitory effect and it is not used as aging inhibitor in the related art. When used with the other aging inhibitor or inhibitors, however, it shows a synergic effect of aging inhibition, as discovered by the present inventors.

Preferably, the aging inhibitor comprises 20 to 35 weight % of 3C, 20 to 35 weight % of MB, and 30 to 70 weight % of a blooming aging inhibitor (e.g., Sunnoc, Suntite, or a mixture thereof), based on the total weight of the aging inhibitor. When MB is used less than 20 weight %, improvement of properties as vibration-proof rubber cannot be attained. And, when it is used in an amount exceeding 35 weight %, no further improvement of properties is attained.

When the blooming aging inhibitor is used less than 30 weight %, it is difficult to form a coating layer. The use of an amount exceeding 70 weight % is economically unfavorable because of the increase in manufacturing cost.

As such, the selection of the aging inhibitor is important. The aging inhibitors act in two different mechanisms. One is through chemical bonding and the other is through blooming to form a coating layer.

In the present invention, for instance, 3C and MB are chemically bonded with natural rubber, and Sunnoc and Suntite are bloomed on the surface of the natural rubber to form an anti-aging layer. Preferably, Suntite with a larger average molecular weight of 1,000 to 2,000 is bloomed first, and then Sunnoc with a smaller average molecular weight of 100 to 500 is bloomed later, so that the anti-aging layer may be formed consistently on the surface.

The weight proportion of Sunnoc to Suntite may be in the range of from 1:0.3 to 1:0.8, more preferably from 1:0.4 to 1:0.6. When the weight proportion is smaller than 1:0.3, consistency of the anti-aging layer may be deteriorated. By contrast, a weight proportion exceeding 1:0.8 is unfavorable because of the increase in manufacturing cost.

The filler is used to prevent aging of the natural rubber and/or make the same stronger and tougher. A preferable example of the filler is carbon black. According to ASTM (American Standard Test Method), carbon black is classified into SAF, ISAF, HAF, XCF, FEF, GPF, SRF, FT and MT, depending on particle size. A suitable carbon black may be carbon black FEF (particle size=40-48 nm) (Corax N550).

### EXAMPLES

The following examples further illustrate the present invention but they should not be construed as limiting the scope of the present invention.

### Example 1

100 g of a natural rubber having a Mooney viscosity of 60 and comprising isoprene as unit molecules was masticated for 2 minutes using a Banbury mixer, followed by mixing for 10 minutes after adding 20 g of carbon black FEF. Subsequently, 8 g of ZnO as a vulcanization aid, 3 g of stearic acid as an activator, 2 g of 3C and 2 g of MB as an aging inhibitor, and 1 g of Sunnoc and 0.5 g of Suntite as a blooming aging inhibitor were added. Carbon master batch was prepared by mixing for 2 minutes.

To such prepared carbon master batch, 0.5 g of sulfur, 0.7 g of PMP and 0.7 g of P900 as a crosslinking agent and 0.8 g of CZ and 1.2 g of TT as a vulcanization accelerator were added, and dispersed and mixed using a roll mixer. After measurement of vulcanization time using a flow meter, the resultant rubber composition was heated to 170° C. and pressed at 210 kgf/cm² to obtain a vibration-proof rubber composition.

### Example 2

A vibration-proof rubber composition was prepared in the same manner as in Example 1, except for adding 0.7 g of HTS instead of P900 in the crosslinking agent, as shown in Table 1 below.

### Example 3

A vibration-proof rubber composition was prepared in the same manner as in Example 1, except for adding sulfur, PMP, P900 and HTS as a crosslinking agent, as shown in Table 1 below.

### Example 4

A vibration-proof rubber composition was prepared in the same manner as in Example 1, except that it comprises 31.3 weight % of 3C, 31.3 weight % of MB and 37.4 weight % of the blooming aging inhibitor, based on the total weight of the aging inhibitor, as shown in Table 1 below.

### Example 5

A vibration-proof rubber composition was prepared in the same manner as in Example 4, except that the weight proportion of Sunnoc to Suntite is 1:0.65, as shown in Table 1 below.

### Example 6

A vibration-proof rubber composition was prepared in the same manner as in Example 1, except for reducing the amount of sulfur added in the crosslinking agent, as shown in Table 1 below.

TABLE 1

| Constituents (parts by weight) | | Ex. 1 | Ex. 2 | Ex. 3 | Ex. 4 | Ex. 5 | Ex. 6 |
|---|---|---|---|---|---|---|---|
| Rubber | Natural | 100 | 100 | 100 | 100 | 100 | 100 |
| | rubber (NR) | | | | | | |
| Crosslinking | Sulfur | 0.5 | 0.5 | 0.4 | 0.5 | 0.5 | 0.3 |
| agent | PMP | 0.7 | 0.7 | 0.6 | 0.7 | 0.7 | 0.9 |
| | P900 | 0.7 | — | 0.6 | 0.7 | 0.7 | 1.1 |
| | HTS | — | 0.7 | 0.6 | — | — | — |
| Vulcanization | CZ | 0.8 | 0.8 | 0.8 | 0.8 | 0.8 | 0.8 |
| accelerator | TT | 1.2 | 1.2 | 1.2 | 1.2 | 1.2 | 1.2 |
| Filler | Carbon black | 20 | 20 | 25 | 20 | 20 | 16 |
| | FEF | | | | | | |
| Activator | Stearic acid | 3 | 3 | 3 | 3 | 3 | 4 |
| | Zinc oxide | 8 | 8 | 8 | 7 | 7 | 5 |
| Aging inhibitor | 3C | 2 | 2 | 2 | 2.5 | 2.5 | 2 |
| | MB | 2 | 2 | 2 | 2.5 | 2.5 | 2 |
| | Sunnoc | 1 | 1 | 1 | 2 | 2 | 1 |
| | Suntite | 0.5 | 0.5 | 0.5 | 1 | 1.3 | 0.5 |

Sulfur: SP400, Midas
PMP: N,N-m-Phenylenedimaleimide
P900: 1,3-Bis(citraconimidomethyl)benzene, Flexsys
HTS: Hexamethylene-1,6-bis(thiosulfate) (disodium salt, dehydrate), Flexsys
CZ: N-cyclehexylbenzothiozole-2-sulfenamide, Oricel CZ, Dong Yang Chemical
TT: Tetramethylthiuram disulfide, Oricel TT, Dong Yang Chemical
Carbon black FEF: Corax N550, Korea Corax
Carbon black MT: Corax N990, Korea Corax
ZnO: Zinc oxide (99.5%), Hanil Zinc Oxide
3C: N-Phenyl-N′-isopropyl-p-phenylenediamine, Kumanox 3C, Kumho Monsanto
MB: 2-Mercaptobenzimidazole, Miwon Chemical
TMDQ: Polymerized 2,2,4-trimethyl-1,2-dihydroquinoline, Rubatan 184-RD, Kumho Monsanto
Sunnoc/Suntite: Microcrystalline wax (hydrocarbon 100%), Seiko Chemical (average molecular weight of Sunnoc = 1400, average molecular weight of Suntite = 350)

### Comparative Example 1

A vibration-proof rubber composition was prepared in the same manner as in Example 1, except for using constituents and proportion thereof as shown in Table 2 below.

### Comparative Example 2

A vibration-proof rubber composition was prepared in the same manner as in Example 1, except for using a synthetic rubber comprising 70 parts by weight of poly-isoprene rubber (hereinafter referred to as “IR”) and 30 parts by weight of poly-butadiene rubber (hereinafter referred to as “BR”) instead of a natural rubber, as shown in Table 2 below.

### Comparative Example 3

A vibration-proof rubber composition was prepared in the same manner as in Example 1, except that it comprises: per 100 parts by weight of synthetic rubber EPDM (ethylene propylene diene monomer), 1 part by weight of sulfur and 3 parts by weight of dicumyl peroxide as conventional hybrid crosslinking agent; 0.5 part by weight of CZ and 2 parts by weight of TT as a vulcanization accelerator; 30 parts by weight of HAF (high abrasion furnace) carbon black (Corax N330, Korea Corax) and 10 parts by weight of SRF (semi-reinforced furnace) carbon black (Corax N774, Korea Corax) as a filler; 2 parts by weight of stearic acid as a vulcanization activator; and 5 parts by weight of zinc oxide and) 0.5 parts by weight of PEG (polyethylene glycol) as an activator.

### Comparative Example 4

A vibration-proof rubber composition was prepared in the same manner as in Example 1, except for using constituents and proportion thereof as shown in Table 2 below.

### Comparative Example 5

A vibration-proof rubber composition was prepared in the same manner as in Example 1, except that the weight proportion of the vulcanization accelerator to the crosslinking agent is 1:1.15, as shown in Table 2 below.

### Comparative Example 6

A vibration-proof rubber composition was prepared in the same manner as in Example 1, except that it comprises 12 weight % of MB based on the total weight of the aging inhibitor, as shown in Table 2 below.

TABLE 2

| | | | Comp. | Comp. | Comp. | Comp. | Comp. |
|---|---|---|---|---|---|---|---|
| Constituents (parts by weight) | | | Ex. 1 | Ex. 2 | Ex. 4 | Ex. 5 | Ex. 6 |
| Rubber | Natural rubber (NR) | | 100 | — | 100 | 100 | 100 |
| | Synthetic | IR⁽¹⁾ | — | 70 | — | — | — |
| | rubber | BR⁽²⁾ | — | 30 | — | — | — |

| | | | | | | |
|---|---|---|---|---|---|---|
| Crosslinking agent | Sulfur | 0.8 | 1.5 | 0.5 | 0.7 | 0.5 |
| | PMP | — | — | — | 0.8 | 0.7 |
| | P900 | — | — | — | 0.8 | 0.7 |
| | HTS | — | — | — | — | — |
| Vulcanization | CZ | 0.5 | — | 0.5 | 0.8 | 2 |
| accelerator | TT | 1.0 | 1.4 | 1.0 | 1.2 | 2 |
| Filler | Carbon black FEF | 25 | 25 | 20 | 20 | 20 |
| | Carbon black MT⁽³⁾ | — | — | 10 | — | — |
| Activator | Stearic acid | 3 | | 3 | 3 | 3 |
| | Zinc oxide | 8 | | 3 | 8 | 8 |
| Aging inhibitor | 3C | 2 | 1.5 | 1 | 2 | 3.8 |
| | MB | — | — | 1.5 | 2 | 0.7 |
| | TMDQ⁽⁴⁾ | 2 | 1.5 | — | — | — |
| | Sunnoc | — | 1.5 | — | 1 | 1 |
| | Suntite | — | — | — | 0.5 | 0.5 |

⁽¹⁾IR: Poly-isoprene rubber, synthetic rubber 99.8% pure as compared to natural rubber
⁽²⁾BR: Poly-butadiene rubber
⁽³⁾Carbon black MT: Corax N990, Korea Corax
⁽⁴⁾TMDQ: Polymerized 2,2,4-trimethyl-1,2-dihydroquinoline, Rubatan 184-RD, Kumho Monsanto Other constituents are the same as in Table 1.

### TEST EXAMPLES

### Test Examples 1 to 6 and Comparative Test Examples 1 to 6

Physical properties of the vibration-proof rubber compositions prepared in Examples 1 to 6 (Test Examples 1 to 6) and Comparative Examples 1 to 6 (Comparative Test Examples 1 to 6) and products prepared therefrom were tested. The result is given in Tables 3 and 4 below. Room temperature durability and heat-resistant durability were tested using engine mount vibration-proof rubber products prepared from the vibration-proof rubber compositions of Examples and Comparative Examples.

TABLE 3

| | | | Test | Test | Test | Test | Test | Test | Aging |
|---|---|---|---|---|---|---|---|---|---|
| | | | Ex. 1 | Ex. 2 | Ex. 3 | Ex. 4 | Ex. 5 | Ex. 6 | condition |
| Sample | Hardness (Hs) | | 45 | 44 | 45 | 45 | 46 | 45 | — |
| | Tensile strength (kgf/cm²) | | 235 | 238 | 240 | 230 | 238 | 245 | |
| | Elongation (%) | | 555 | 560 | 580 | 558 | 540 | 515 | |
| | Change of hardness after | | +3 | +5 | +5 | +3 | +3 | +5 | 100° C. × |
| | aging | | | | | | | | 1,000 hr |
| | Change | Tensile | −28 | −34 | −39 | −26 | −20 | −25 | |
| | after aging | strength | | | | | | | |
| | (%) | Elongation | −17 | −25 | −26 | −19 | −13 | −28 | |

| | Permanent compression set | 15 | 17 | 18 | 15 | 12 | 18 | 100° C. × |
|---|---|---|---|---|---|---|---|---|
| | (%) | | | | | | | 22 hr |
| Product | Room temperature durability | 206 | 178 | 171 | 198 | 190 | 166 | Room |
| | (1 × 10⁴ cycles) | | | | | | | temperature |
| | Heat-resistant durability | 85 | 68 | 66 | 87 | 97 | 65 | 120° C. × |
| | (1 × 10⁴ cycles) | | | | | | | 100 hr |
| | Dynamic magnification | 1.40 | 1.36 | 1.42 | 1.41 | 1.41 | 1.43 | — |

Measurement was made as follows.
1. Hardness: Measured according to KS M 6784.
2. Tensile strength, elongation and modulus: Measured according to KS M 6782 using dumbbell No. 3.
3. Aging properties: Measurement was made after aging at 100° C. for 1,000 hours.
4. Heat-resistant durability: Durability was measured after aging at 120° C. for 100 hours.
5. Dynamic magnification = dynamic spring constant/static spring constant (Lower dynamic magnification means better dynamic characteristics.).

TABLE 4

| | | | Comp. | Comp. | Comp. | Comp. | Comp. | Comp. | |
|---|---|---|---|---|---|---|---|---|---|
| | | | Test | Test | Test | Test | Test | Test | Aging |
| | | | Ex. 1 | Ex. 2 | Ex. 3 | Ex. 4 | Ex. 5 | Ex. 6 | condition |
| Sample | Hardness (Hs) | | 45 | 47 | 48 | 45 | 47 | 45 | — |
| | Tensile strength | | 245 | 180 | 215 | 250 | 244 | 235 | |
| | (kgf/cm²) | | | | | | | | |
| | Elongation (%) | | 610 | 590 | 460 | 590 | 564 | 550 | |
| | Change of hardness | | +8 | +7 | +2 | +6 | +4 | +5 | 100° C. × |
| | after aging | | | | | | | | 1,000 hr |
| | Change | −68 | −51 | −38 | −50 | −35 | −40 | −25 | |
| | after | −57 | −48 | −32 | −45 | −27 | −39 | −28 | |
| | aging (%) | | | | | | | | |

| | | | | | | | | |
|---|---|---|---|---|---|---|---|---|
| | Permanent | 20 | 30 | 31 | 18 | 15 | 20 | 100° C. × |
| | compression set (%) | | | | | | | 22 hr |
| Product | Room temperature | 150 | 95 | 35 | 105 | 200 | 208 | Room |
| | durability (1 × 10⁴ | | | | | | | temperature |
| | cycles) | | | | | | | |
| | Heat-resistant | 25 | 20 | 20 | 32 | 56 | 58 | 120° C. × |
| | durability (1 × 10⁴ | | | | | | | 100 hr |
| | cycles) | | | | | | | |
| | Dynamic | 1.54 | 1.35 | 1.58 | 1.48 | 1.38 | 1.41 | — |
| | magnification | | | | | | | |

Measurement was made in the same manner as in Table 3.

As shown in Tables 3 and 4, Test Examples and Comparative Test Examples showed almost the same result in hardness, tensile strength and elongation. However, after aging, Test Examples exhibited superior result to Comparative Test Examples in change thereof. Especially, Test Examples exhibited less change in tensile strength and elongation after aging, as compared to Comparative Test Examples. Thus, it can be seen that the vibration-proof rubber compositions of the present invention have superior aging resistance.

Further, Test Examples exhibited better result in room temperature durability and heat-resistant durability tests than Comparative Test Examples. Therefore, it can be seen that the vibration-proof rubber compositions of the present invention have superior fatigue characteristics, including durability, heat resistance, etc., and are suitable to be used for engine mounts operated at high temperature.

Test Examples also exhibited significantly lower dynamic magnification than conventional vibration-proof rubber compositions for an engine mount (Comparative Tests Examples 1, 3 and 4). Thus, it can be seen that the vibration-proof rubber compositions for an engine mount of the present invention have superior dynamic characteristics.

Comparative Test Example 5, wherein the weight proportion of the vulcanization accelerator to the crosslinking agent was 1:1.15, exhibited superior dynamic characteristics, but poor aging characteristics.

Comparative Test Example 6, wherein MB was used less than 15 weight %, exhibited better physical properties than conventional vibration-proof rubber compositions for an engine mount (Comparative Test Examples 1 to 4). But, when comparing with the present invention (Test Examples 1 to 6), it exhibited worse heat-resistant durability. Thus, it can be seen that MB has to be added in an amount not less than 15 weight % in order to attain good heat resistance.

To conclude, the vibration-proof rubber compositions of the present invention were superior in durability, heat resistance, fatigue characteristics, dynamic characteristics, etc., when compared with conventional vibration-proof rubber compositions for an engine mount.

The vibration-proof rubber provided by the present invention has superior heat resistance, dynamic characteristics and durability than conventional vibration-proof rubber, and seems to be industrially useful for engine mounts for airplanes, ships, tillers, motorbikes and automobiles.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A vibration-proof rubber composition comprising a natural rubber, a crosslinking agent, a vulcanization accelerator, an activator, an aging inhibitor and a filler, and at least one of the hybrid crosslinking system 1 and the hybrid crosslinking system 2 shown below: 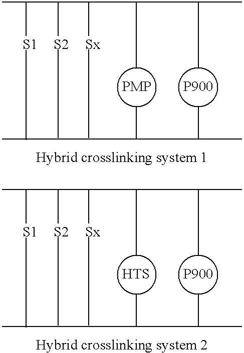
wherein PMP refers to N,N-m-phenylenedimaleimide, P900 to 1,3-bis-(citraconimidomethyl)benzene, and HTS to hexamethylene-1,6-bis(thiosulfate).

2. The vibration-proof rubber composition according to claim 1, which comprises: per 100 parts by weight of the natural rubber,
1.5 to 3 parts by weight of the vulcanization accelerator;
0.2 to 0.7 parts by weight of sulfur and 1 to 2.8 parts by weight of a heat-resistant crosslinking agent as the crosslinking agent;
8 to 12 parts by weight of the activator;
to 10 parts by weight of the aging inhibitor; and
to 50 parts by weight of the filler,
wherein the weight ratio of the vulcanization accelerator to the crosslinking agent is from 1:0.7 to 1:1.

3. The vibration-proof rubber composition according to claim 1, wherein the natural rubber has a Mooney viscosity in the range of from 50 to 70.

4. The vibration-proof rubber composition according to claim 3, wherein the natural rubber has CH₂═C(CH₃)—CH═CH₂ as a repeating unit.

5. The vibration-proof rubber composition according to claim 2, wherein the heat-resistant crosslinking agent comprises PMP and at least one of P900 and HTS.

6. The vibration-proof rubber composition according to claim 1, wherein the vulcanization accelerator comprises at least one of N-cyclohexylbenzothiazole-2-sulfenamide (CZ) and tetramethylthiuram disulfide (TT).

7. The vibration-proof rubber composition according to claim 1, wherein the activator comprises at least one of stearic acid and zinc oxide (ZnO).

8. The vibration-proof rubber composition according to claim 1, wherein the aging inhibitor comprises at least one of N-phenyl-N′-isopropyl-p-phenylenediamine (3C) and 2-mercaptobenzimidazole (MB) and a blooming aging inhibitor.

9. The vibration-proof rubber composition according to claim 1, wherein the blooming aging inhibitor is at least one of Sunnoc and Suntite.

10. The vibration-proof rubber composition according to claim 8, wherein the aging inhibitor comprises 20 to 35 weight % of N-phenyl-N′-isopropyl-p-phenylenediamine (3C), 20 to 35 weight % of 2-mercaptobenzimidazole (MB), and 30 to 70 weight % of the blooming aging inhibitor, based on the total weight of the aging inhibitor.

11. The vibration-proof rubber composition according to claim 10, wherein the aging inhibitor comprises 20 to 35 weight % of N-phenyl-N′-isopropyl-p-phenylenediamine (3C), 20 to 35 weight % of 2-mercaptobenzimidazole (MB), and 30 to 70 weight % of the Sunnoc and/or Suntite, based on the total weight of the aging inhibitor.

12. The vibration-proof rubber composition according to claim 11, wherein weight ratio of the Sunnoc to the Suntite is from 1:0.3 to 1:0.7.

13. The vibration-proof rubber composition according to claim 11, wherein the Sunnoc has an average molecular weight in the range of from 1,000 to 2,000 and the Suntite has an average molecular weight in the range of from 100 to 500.

14. The vibration-proof rubber composition according to claim 1, wherein the filler comprises carbon black FEF (fast extrusion furnace) with a particle size in the range of from 40 to 48 nm.
